(19) United States
(12) Patent Application Publication
(10) Pub. No.: US 2014/0284826 A1
(43) Pub. Date: Sep. 25, 2014

(54) DEVICE FOR MANUFACTURING OPTICAL FILM AND A METHOD FOR MANUFACTURING THE SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/108,359

(22) Filed: Dec. 17, 2013

(30) Foreign Application Priority Data
Mar. 22, 2013 (TW) 102110212

(51) Int. Cl. B29D 11/00

(52) U.S. Cl. CPC B29D 11/00788
USPC 264/1.38; 425/115

(57) ABSTRACT

A device includes a feed unit containing hot melted UV curable glue, a first pressing roller defining a first central axis, a second pressing roller defining a second central axis, and two UV lamp assemblies received in the two pressing rollers respectively. The first pressing roller rotates about the first central axis in a first direction. The second pressing roller rotates about the second central axis in a second direction opposite to the first direction. The first central axis and the second central axis are arranged on a common horizontal plane and parallel to each other. A molding channel is formed between the two pressing rollers. The two pressing rollers cooperatively press the hot melted UV curable glue transmitted into the molding channel from the feed unit. The UV lamp assemblies emit UV light beams to solidify the pressed UV curable glue to form an optical film.

### BACKGROUND

1. Technical Field

The present disclosure relates to a device for manufacturing an optical film and a method for manufacturing the optical film using the device.

2. Description of Related Art

Optical films, such as diffusion films, brightness enhancement films, or prism sheets are preferred for using in a backlight module for guiding light. An optical film usually includes a number of microstructures. The optical film with the microstructures can be manufactured through a printing method.

However, the above mentioned printing method must employ a polyethylene terephthalate (PET) film as a carrier, on which ultraviolet (UV) curable glue is adhered. This increases a total thickness of the optical film. Furthermore, the light transmission of the optical film is restricted since the light transmission of the PET film is about 90%, not about 100%.

Therefore, it is desirable to provide a device for manufacturing the optical film and a method for manufacturing the optical film using the device, which can overcome or alleviate the above-mention problems.

### BRIEF DESCRIPTION OF THE DRAWINGS

FIG. 1 is a schematic view of a device for manufacturing an optical film, according to a first exemplary embodiment.

FIG. 2 is a schematic view of a gluing wheel of the device of FIG. 1.

FIG. 3 is a schematic view of a device for manufacturing an optical film, according to a second exemplary embodiment.

### DETAILED DESCRIPTION

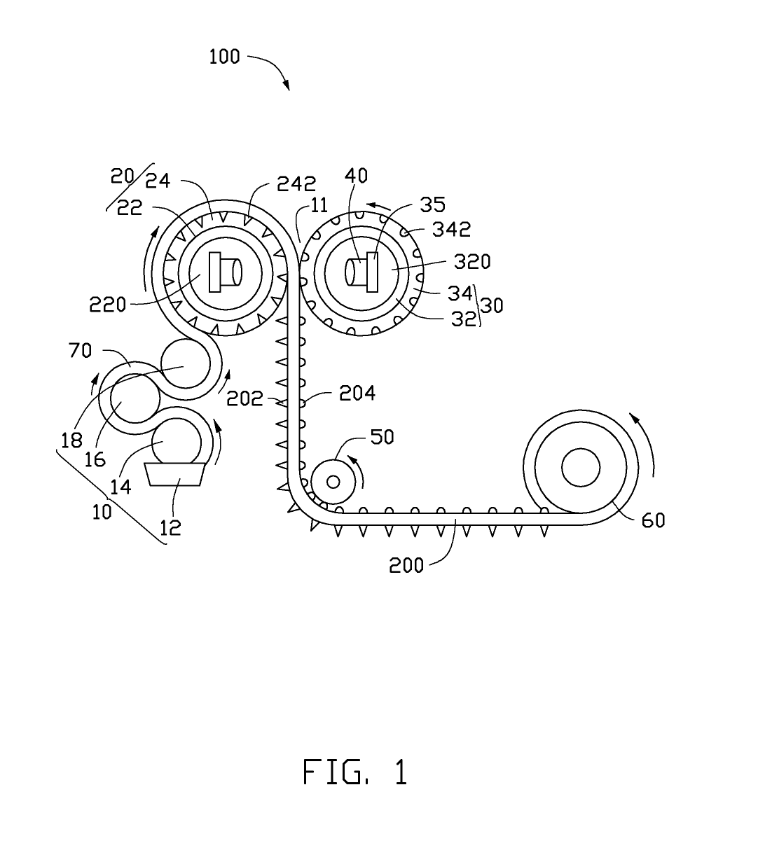

Referring to FIG. 1, a device 100 for manufacturing an optical film 200, according to a first exemplary embodiment, is shown. The device 100 includes a feed unit 10, a first pressing roller 20, a second pressing roller 30, two UV lamp assemblies 40, a transmission roller 50 and a winding roller 60. In this embodiment, the optical film 200 may be a diffusion film, a brightness enhancement film, or a prism sheet.

The feed unit 10 includes a tank 12, a glue-fetching wheel 14, a first gluing wheel 16 and a second gluing wheel 18.

The tank 12 is substantially trapezoid and is configured to contain hot melted UV curable glue 70.

The glue-fetching wheel 14 is positioned above the tank 12, and part of the glue-fetching wheel 14 is immersed in the hot melted UV curable glue 70. The glue-fetching wheel 14 defines a first axis (not labeled and which is perpendicular to the paper) in a central portion thereof and rotates about the first axis.

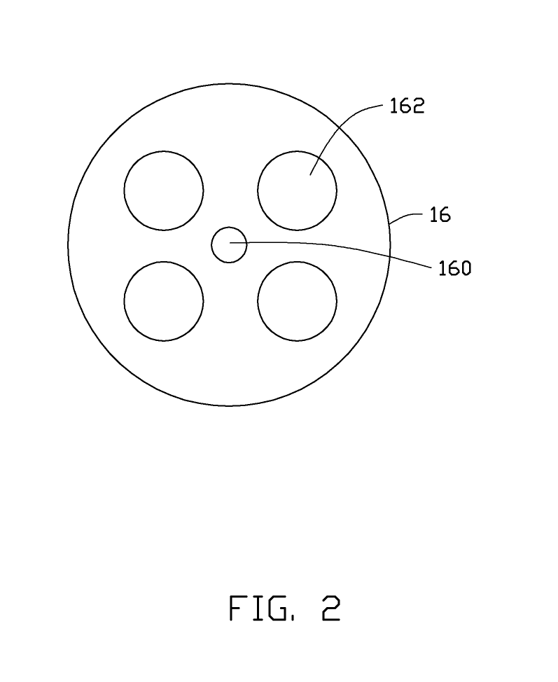

The first gluing wheel 16 is positioned above the glue-fetching wheel 14 and is spaced apart from the glue-fetching wheel 14. The first gluing wheel 16 defines a second axis 160 (shown in FIG. 2) in a central portion thereof and rotates about the second axis 160. Referring to FIG. 2, the first gluing wheel 16 includes a water cycle system 162 surrounding the second axis 160. Water with lower temperature fills in the water cycle system 162.

The second gluing wheel 18 is positioned above the first gluing wheel 16 and is spaced apart from the first gluing wheel 16. The second gluing wheel 18 defines a third axis (not labeled and which is perpendicular to the paper) in a central portion thereof and rotates about the third axis.

The first axis, the second axis 160 and the third axis are parallel with each other. A rotating direction of the first gluing wheel 16 is opposite to a rotating direction of the glue-fetching wheel 14. The rotating direction of the first gluing wheel 16 is opposite to a rotating direction of the second gluing wheel 18. In this embodiment, the glue-fetching wheel 14 rotates counterclockwise. The first gluing wheel 16 rotates clockwise. The second gluing wheel 18 rotates counterclockwise. The hot melted UV curable glue 70 is transferred on to the glue-fetching wheel 14 when the glue-fetching wheel 14 rotates. The hot melted UV curable glue 70 is transferred on to the first gluing wheel 16 and is cooled by the water cycle system 162 when the first gluing wheel 16 rotates. The cooled UV curable glue 70 is transferred on to the second gluing wheel 18 when the second gluing wheel 18 rotates.

The first pressing roller 20 and the second pressing roller 30 are positioned above the second gluing wheel 18. The first pressing roller 20 defines a first central axis (not labeled and which is perpendicular to the paper) in a central portion thereof and rotates about the first central axis. The second pressing roller 30 defines a second central axis (not labeled and which is perpendicular to the paper) in a central portion thereof and rotates about the second central axis. The first central axis and the second central axis are arranged on a same plane, such as a common horizontal plane, and parallel to each other. A rotating direction of the first pressing roller 20 is opposite to a rotating direction of the second pressing roller 30. In this embodiment, the first pressing roller 20 rotates clockwise, and the second pressing roller 30 rotates counterclockwise.

Specifically, the first pressing roller 20 and the second pressing roller 30 are located nearby each other and spaced at a predetermined distance from each other. A molding channel 11 is formed between the first pressing roller 20 and the second pressing roller 30. The cooled UV curable glue 70 is transferred into the molding channel 11. The distance between the first pressing roller 20 and the second pressing roller 30 is substantially equal to a predetermined thickness of the optical film 200 to be manufactured.

The first pressing roller 20 and the second pressing roller 30 cooperate to press the cooled UV curable glue 70. The first pressing roller 20 includes a first main body 22 and a first mold core 24. The first main body 22 is substantially a hollow cylinder and defines a first cavity 220 in a central portion thereof. The first mold core 24 is sleeved on and firmly adhered to the first main body 22. The first mold core 24 defines a number of first microstructures 242 on an outer circumferential surface thereof. In this embodiment, the first main body 22 is coaxial with the first mold core 24, and the axes of the first main body 22 and the first mold core 24 coincide with the first central axis.

The second pressing roller 30 includes a second main body 32 and a second mold core 34. The second main body 32 is substantially a hollow cylinder and defines a second cavity 320 in a central portion thereof. The second mold core 34 is sleeved on and firmly adhered to the second main body 32. The second mold core 34 defines a number of second microstructures 342 on an outer circumferential surface thereof. In this embodiment, the second main body 32 is coaxial with the second mold core 34, and the axes of the second main body 32 and the second mold core 34 coincide with the second central axis.

In this embodiment, the first main body 22 and the second main body 32 are made of quartz which can allow 90% UV to penetrate. In other embodiments, the first main body 22 and the second main body 32 may be made of other transparent material, such as silicon dioxide (SiO₂). The first mold core 24 and the second mold core 34 are made of polydimethylsiloxane (PDMS) which has low surface energy and is flexible. The first microstructures 242 and the second microstructures 342 are formed by a roller pressing method or a laser ablating method. Each of the first microstructures 242 is substantially a V-shaped recess, and each of the second microstructures 342 is substantially a dot-shaped recess. The shape of the first microstructures 242 and the second microstructures 342 are not limited to the above mentioned shape and may be pyramid-shaped or frustum-cone-shaped. In addition, the shape of the first microstructures 242 may be the same as the shape of the second microstructures 342.

The two UV lamp assemblies 40 are received in the first cavity 220 and the second cavity 320, respectively. In detail, the two UV lamp assemblies 40 are positioned in central portion of the first cavity 220 or the second cavity 320 and apart from the two pressing rollers 20 and 30. That is, the UV lamp assemblies 40 are stationary when the two pressing rollers 20 and 30 rotate. The UV lamp assemblies 40 are configured to solidify the cooled UV curable glue 70 pressed by the first pressing roller 20 and the second pressing roller 30. The UV lamp assembly 40 in the first cavity 220 emits UV light beams toward the second pressing roller 30. The UV lamp assembly 40 in the second cavity 320 emits UV light beams toward the first pressing roller 20.

The transmission roller 50 is a hollow cylinder and positioned under the second pressing roller 30. The transmission roller 50 defines a third central axis (not labeled and which is perpendicular to the paper) in a central portion thereof and rotates about the third central axis. The third central axis and the second central axis are arranged on a same plane, such as a common vertical plane, and parallel to each other. The transmission roller 50 is configured to transmit the solidified UV curable glue 200 to the winding roller 60.

The winding roller 60 is a hollow cylinder and is configured to wind up the solidified UV curable glue 70. The winding roller 60 defines a fourth central axis (not labeled and which is perpendicular to the paper) in a central portion thereof and rotates about the fourth central axis. The fourth central axis and the third central axis are arranged on a same plane, such as a common horizontal plane, and parallel to each other.

A method for manufacturing the optical 200 includes the following steps.

In step I, a device 100 is provided. Hot melted UV curable glue 70 fills in the tank 12, and water with lower temperature fills in the water cycle system 162.

In step II, the glue-fetching wheel 14 rotates counterclockwise, the first gluing wheel 16 rotates clockwise, the second gluing wheel 18 rotates counterclockwise, the first pressing roller 20 rotates clockwise, and the second pressing roller 30 rotates counterclockwise, thus the hot melted UV curable glue 70 is transferred on to the glue-fetching wheel 14 and is cooled by the water cycle system 162, the cooled UV curable glue 70 is transferred to the molding channel 11 and is pressed by the first pressing roller 20 and the second pressing roller 30 to imprint first microstructures 242 and second microstructures 342 on opposite surfaces of the pressed UV curable glue 70.

In step III, the pressed UV curable glue 70 is solidified by UV light beams to form an optical film 200. This step can be implemented by two UV lamp assemblies 40 received in the first cavity 220 and in the second cavity 320. A number of first protrusions 202 are formed on a first surface of the optical film 200, and a number of second protrusions 204 are formed on a second surface opposite to the first surface of the optical film 200. The shape of the first protrusions 202 matches with that of the first microstructure 242, and the shape of the second protrusions 204 matches with that of the second microstructures 342.

In step IV, the optical film 200 is transmitted using a transmission roller 50.

In step V, the optical film 200 is winded up using a winding roller 60.

The glue-fetching wheel 14, the first gluing wheel 16, the second gluing wheel 18, the first pressing roller 20, the second pressing roller 30, the transmission roller 50 and the winding roller 60 can be driven by motors (not shown).

In the device 100 and during the steps of the method for manufacturing the optical film 200, a carrier (such as a PET film) is omitted. Therefore, the thickness of the manufactured optical film 200 can be reduced, and the light transmission of the manufactured optical film 200 can be enhanced. Furthermore, the optical film 200 is easily separated from the first pressing roller 20 and the second pressing roller 30 because the first mold core 24 and the second mold core 34 of PDMS material have low surface energy.

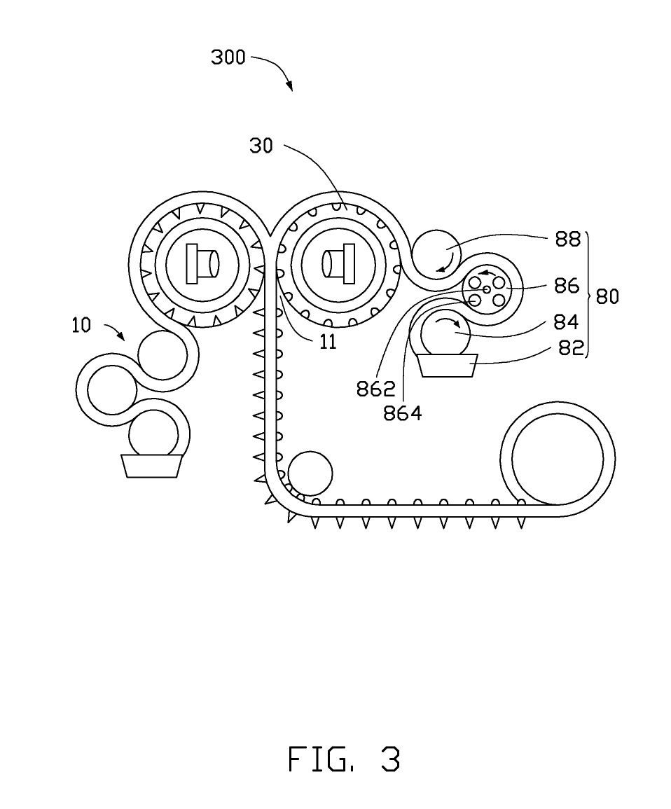

Referring to FIG. 3, a device 300 for manufacturing the optical film 200, according to a second exemplary embodiment, is shown. Differences between the device 300 of this embodiment and the device 100 of the first embodiment are: the device 300 further includes another feed unit 80. The feed unit 80 is positioned at a right side of the second pressing roller 30. The feed unit 80 includes a tank 82, a glue-fetching wheel 84, a first gluing wheel 86 and a second gluing wheel 88.

The tank 82 is substantially trapezoid and is configured to contain hot melted UV curable glue 70.

The glue-fetching wheel 84 is positioned above the tank 82, and part of the glue-fetching wheel 84 is immersed in the hot melted UV curable glue 70. The glue-fetching wheel 84 defines a fourth axis (not labeled and which is perpendicular to the paper) in a central portion thereof and rotates about the fourth axis.

The first gluing wheel 86 is positioned above the glue-fetching wheel 84 and is spaced apart from the glue-fetching wheel 84. The first gluing wheel 86 defines a fifth axis (not labeled and which is perpendicular to the paper) in a central portion thereof and rotates about the fifth axis 860. The first gluing wheel 86 includes a water cycle system 862 surrounding the fifth axis 860. Water with lower temperature fills in the water cycle system 862.

The second gluing wheel 88 is positioned above the first gluing wheel 86 and is spaced apart from the first gluing wheel 86. The second gluing wheel 88 defines a sixth axis (not labeled and which is perpendicular to the paper) in a central portion thereof and rotates about the sixth axis.

The fourth axis, the fifth axis and the sixth axis are parallel with each other. A rotating direction of the first gluing wheel 86 is opposite to a rotating direction of the glue-fetching wheel 84. The rotating direction of the first gluing wheel 86 is opposite to a rotating direction of the second gluing wheel 88. In this embodiment, the glue-fetching wheel 84 rotates clockwise. The first gluing wheel 86 rotates counterclockwise. The second gluing wheel 88 rotates clockwise.

The hot melted UV curable glue 70 is transferred on to the glue-fetching wheel 84 when the glue-fetching wheel 84 rotates. The hot melted UV curable glue 70 is transferred on to the first gluing wheel 86 and is cooled by the water cycle system 862 when the first gluing wheel 86 rotates. The cooled UV curable glue 70 is transferred on to the second gluing wheel 88 when the second gluing wheel 88 rotates. That is, the cooled UV curable glue 70 from the feed unit 10 and the cooled UV curable glue 70 from the feed unit 80 are transferred into the molding channel 11, and are then pressed by the first and second pressing rollers 20 and 30.

Advantages of the device 300 of the third embodiment are similar to the advantages of the device 100 of the first embodiment.

Even though numerous characteristics and advantages of the present embodiments have been set fourth in the foregoing description, together with details of the structures and functions of the embodiments, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A device for manufacturing an optical film, comprising:
a first feed unit comprising a first tank, a first glue-fetching wheel, a first gluing wheel and a second gluing wheel, the first tank configured to contain hot melted UV curable glue, the first glue-fetching wheel configured to fetch the hot melted UV curable glue in the first tank, the first gluing wheel configured to cool the hot melted UV curable glue and to transfer the cooled UV curable glue to the second gluing wheel, the second gluing wheel configured to transmit the cooled UV curable glue;
a first pressing roller defining a first central axis, the first pressing roller comprising a first main body and a first mold core sleeved on and firmly adhered to the first main body, the first pressing roller configured for rotating about the first central axis in a first direction;
a second pressing roller defining a second central axis, the second pressing roller comprising a second main body and a second mold core sleeved on and firmly adhered to the second main body, the second pressing roller configured for rotating about the second central axis in a second direction opposite to the first direction, the first central axis and the second central axis arranged on a common horizontal plane and parallel to each other, a molding channel formed between the first pressing roller and the second pressing roller, the first pressing roller and the second pressing roller cooperatively pressing the cooled UV curable glue transmitted from the second gluing wheel; and
two UV lamp assemblies received in the first pressing roller and the second pressing roller respectively, the UV lamp assemblies configured for emitting UV light beams to solidify the pressed UV curable glue to form the optical film.

2. The device as claimed in claim 1, wherein the first molding core defines a plurality of first microstructures on an outer circumferential surface thereof.

3. The device as claimed in claim 2, wherein the second molding core defines a plurality of second microstructures on an outer circumferential surface thereof.

4. The device as claimed in claim 3, wherein each of the first microstructures is substantially a V-shaped recess, and each of the second microstructures is substantially a dot-shaped recess.

5. The device as claimed in claim 1, wherein the first main body and the second main body are made of quartz.

6. The device as claimed in claim 1, wherein the first mold core and the second mold core are made of polydimethylsiloxane.

7. The device as claimed in claim 3, further comprising a winding roller, wherein the winding roller is configured for winding up the optical film thereon.

8. The device as claimed in claim 7, further comprising a transmission roller, wherein the transmission roller is configured for transmitting the optical film to the winding roller.

9. The device as claimed in claim 8, wherein the transmission roller defines a third central axis in a central portion thereof, the winding roller defines a fourth central axis in a central portion thereof, the third central axis and the second central axis are arranged on a common vertical plane, and the third axis and the fourth central axis are arranged on a common horizontal plane.

10. The device as claimed in claim 9, further comprising a second feed unit, wherein the second feed unit comprising a second tank, a second glue-fetching wheel, a third gluing wheel, and a fourth gluing wheel, the second tank configured to contain hot melted UV curable glue, the second glue-fetching wheel configured to fetch the hot melted UV curable glue in the second tank, the third gluing wheel configured to cool the hot melted UV curable glue and to transfer the cooled UV curable glue to the fourth gluing wheel, the fourth gluing wheel configured to transfer the cooled UV curable glue to molding channel.

11. A method for manufacturing an optical film, comprising:
providing a first feed unit, the first feed unit comprising a first tank, a first glue-fetching wheel, a first gluing wheel and a second gluing wheel, the first tank configured to contain hot melted UV curable glue, the first glue-fetching wheel configured to fetch the hot melted UV curable glue in the first tank, the first gluing wheel configured to cool the hot melted UV curable glue and to transfer the cooled UV curable glue to the second gluing wheel, the second gluing wheel configured to transmit the cooled UV curable glue;
providing a first pressing roller, a second pressing roller, and two UV lamp assemblies, the first pressing roller and the second pressing roller arranged side by side and spaced a distance from each other to form a molding channel, the first pressing roller comprising a first main body and a first mold core sleeved on and firmly adhered to the first main body, the first mold core defining a plurality of first microstructures on an outer circumferential surface thereof, the second pressing roller comprising a second main body and a second mold core sleeved on and firmly adhered to the second main body, the second mold core defining a plurality of second microstructures on an outer circumferential surface thereof, the two UV lamp assemblies received in the first pressing roller and the second pressing roller respectively;
rotating the first glue-fetching wheel, the first gluing wheel, the second gluing wheel, the first pressing roller and the second pressing roller, thus the hot melted UV curable glue transferred to the molding channel;
pressing the UV curable glue using the first pressing roller and the second pressing roller to imprint first microstructures and second microstructures on opposite surfaces of the pressed UV curable glue;
solidifying the pressed UV curable glue using UV light beams emitted from the UV lamp assemblies to form the optical film.

12. The method as claimed in claim 12, further comprising:
winding up the optical film on a winding roller.

13. The method as claimed in claim 13, further comprising:
transmitting the optical film using a transmission roller toward the winding roller before winding up the optical film.
